(19) United States
(12) Patent Application Publication
(10) Pub. No.: US 2018/0001358 A1
(43) Pub. Date: Jan. 4, 2018

(54) INHIBITION OF METHANOGENESIS IN REDUCING ENVIRONMENTS

(71) Applicant: Innovative Environmental Technologies, Inc, Pipersville, PA (US)

(72) Inventors: Michael Scalzi, Doylestown, PA (US); James Mueller, Freeport, IL (US); Antonis Karachalios, Hatfield, PA (US)

(21) Appl. No.: 15/408,145

(22) Filed: Jan. 17, 2017

Related U.S. Application Data
(60) Provisional application No. 62/279,519, filed on Jan. 15, 2016.

(51) Int. Cl. B09C 1/08; A01N 65/44; B09C 1/00; A01N 65/24; A01N 65/42; C02F 3/34; C02F 103/06; C02F 101/32; C02F 101/36

(52) U.S. Cl. CPC B09C 1/08; A01N 65/42; A01N 65/44; B09C 1/002; C02F 3/34; A01N 65/24; C02F 2101/32; C02F 2101/36; C02F 2103/06; B09C 2101/00

(57) ABSTRACT

Providing essential oils and/or saponins such as, garlic oil, cinnamon bark oil or powder, and lemongrass oil to an environmental medium to disrupt the enzyme and coenzyme systems, that are integral parts of the methanogenesis process. The disruption limits the growth and reproduction of the methanogens that normally compete with slower-growing, halo-respiring bacteria for the hydrogen donors within the environmental medium (either naturally occurring or provided via fermentable substrates provided to the environmental medium of part of a reduction process). The amount of methane produced during in situ remediation processes is also reduced. The essential oils/saponins are harmless to the slower-growing, halo-respiring bacteria that are utilized to dechlorinate containments in the environmental medium. The essential oils/saponins can be provided alone or along with various organic hydrogen donors, zero-valent iron (ZVI) or other surfactants in order to enhance the biodegradation (reductive dechlorination) of the targeted contaminants.

### PRIORITY

This application claims the priority under 35 USC §119 of Provisional Application 62/279,519 filed on Jan. 15, 2016, entitled “Inhibition of Methanogenesis During Environmental Applications” and having Mike Scalzi, James Mueller and Antonis Karachalios as inventors. Application 62/279,519 is herein incorporated by reference in its entirety.

### BACKGROUND

Soil and groundwater at contaminated sites often contain chlorinated aliphatic hydrocarbons (CAHs) of anthropogenic origin such as tetrachloroethene (PCE), trichloroethene (TCE), carbon tetrachloride (CT), chloroform (CF) and methylene chloride (MC). In addition, (bio)degradation products, including dichloroethane (DCA), dichloroethene (DCE), and vinyl chloride (VC) can be present which represent additional hazards to public health and the environment.

In situations where remedial actions are warranted, in situ bioremediation-based processes often represent the most efficacious options, when applicable. The environmental biogeochemistry of each site largely determines the rate of biodegradation of CAHs observed. The initial catabolic reactions usually involve a biochemical process described as sequential biological reductive dechlorination. The occurrence of different types and concentrations of electron donors such as native organic matter, and electron acceptors such as oxygen and chlorinated solvents, determines to a large degree the extent to which reductive dechlorination occurs at a given site.

By definition, reductive dechlorination occurs in the absence of oxygen, with the chlorinated solvent substituting for oxygen in the physiology of the microorganisms carrying out the process. Based on thermodynamic considerations, reductive dechlorination will occur only after both oxygen and nitrate have been depleted from the aquifer since oxygen and nitrate are more energetically favorable electron acceptors than chlorinated solvents.

Multiple microorganisms, especially bacteria, will assist in removing oxygen and nitrates from the applied systems, and these biological processes often are used and manipulated to create the environmental conditions necessary for optimal destruction of the CAH contaminants. Bacteria generally are categorized by: 1) the means by which they derive energy, 2) the type of electron donors they require, or 3) the source of carbon that they require. Bacteria are classified further by the electron acceptor that they use, and therefore the type of zone that will dominate in the subsurface. A bacteria electron acceptor class causing a redox reaction generating relatively more energy, will dominate over a bacteria electron acceptor class causing a redox reaction generating relatively less energy.

Typically, bacteria that are involved in the biodegradation of CAHs in the subsurface are chemotrophs (bacteria that derive their energy from chemical redox reactions) and use organic compounds as electron donors and sources of organic carbon (organoheterotrophs). Heterotrophic bacteria are often used to consume dissolved oxygen, thereby reducing the redox potential in the ground water. In addition, as the bacteria grow on the organic particles, they ferment carbon and release a variety of volatile fatty acids (e.g., acetic, propionic, butyric), which diffuse from the site of fermentation into the ground water plume and serve as electron donors for other bacteria, including dehalogenators and halorespiring species.

Almost any substrate that can be fermented to hydrogen (H₂) can be used to enhance reductive dechlorination since these materials are used by dechlorinating microorganisms such as Dehalococcoides sp., Dehalobacter sp and numerous others. Laboratory studies have shown that a wide variety of organic substrates can serve as hydrogen donors (organic hydrogen donors) when they ferment to stimulate biological reductive dechlorination. These include acetate, propionate, butyrate, benzoate, glucose, lactate, methanol, and/or toluene. Inexpensive, more organically complex substrates such as molasses, cheese whey, corn steep liquor, corn oil, hydrogenated cottonseed oil beads, solid food shortening, beef tallow, melted corn oil margarine, coconut oil, soybean oil, and/or hydrogenated soybean oil and emulsifications thereof also have the potential to support reductive biological dechlorination by liberating hydrogen.

However, hydrogen is also a substrate for methanogenic bacteria that quickly convert the hydrogen into methane and remove it from the biochemical cycle. Methanogens typically thrive in environments in which all electron acceptors (e.g., oxygen, nitrate, trivalent iron, and sulfate) other than carbon dioxide (CO₂) have been depleted. As such, methanogens are often the dominant domain of microbe present in an aquifer (reducing environment). Notably, methanogens have significantly faster rates of growth and reproduction (e.g., >10×) as compared to known microbes with the ability to dehalogenate CAHs (e.g., Dehalococcoides sp).

By utilizing H₂, the methanogens compete with the dechlorinating microbes. Competition for H₂ is undesirable as this translates to additional cost during a remedial action as the generation and release of methane represents a waste of generated hydrogen. In addition, excessive methanogenesis under certain environmental settings can cause significant issues in terms of health and safety (e.g., methane is flammable; methane production can induce migration of CAHs yielding secondary in-door air issues).

What is needed is a means for controlling methanogenesis that occurs within a reducing environment. Such a reduction will help dehalogenating bacteria to more effectively utilize the environmental conditions (the available H₂) that promote reductive dechlorination of CAHs during in situ remediation processes. Furthermore, the amount of methane production will also be lowered.

### BRIEF DESCRIPTION OF THE DRAWINGS

The features and advantages of the various embodiments will become apparent from the following detailed description in which:

FIG. 1 illustrates a CO₂—CH₄ reduction pathway that occurs within methanogens.

FIG. 2 is a table that defines the various different essential oils that were tested to determine their effect on methane production.

FIGS. 3-5 are tables showing the test for the essential oils defined in FIG. 2 for 3 time intervals (3, 7 and 12 days after the essential oils were added).

FIG. 6 is a graph showing the results of the methane produced for the tests of FIGS. 3-5.

### DETAILED DESCRIPTION

Biological methane formation is a microbial process catalyzed by methanogens. As used herein, the term methanogen refers to methane-producing organisms including both methane-producing bacteria and to Archaea (formerly classified as archaebacteria.) The methanogenic pathways of all species of methanogens have in common the conversion of a methyl group to methane; however the origin of the methyl group varies. Most species are capable of reducing carbon dioxide (CO₂) to a methyl group with either a molecular hydrogen (H₂) or formate as the reductant. Methane (CH₄) production pathways in methanogens that utilize CO₂ and H₂ involve specific methanogen enzymes, which catalyze unique reactions using unique coenzymes. The CH₄ production pathway is captured by the overall reaction noted below (reaction 1).

4H₂+CO₂→CH₄+2H₂O, with ΔG°′=−130.4 kJ/mol (1)

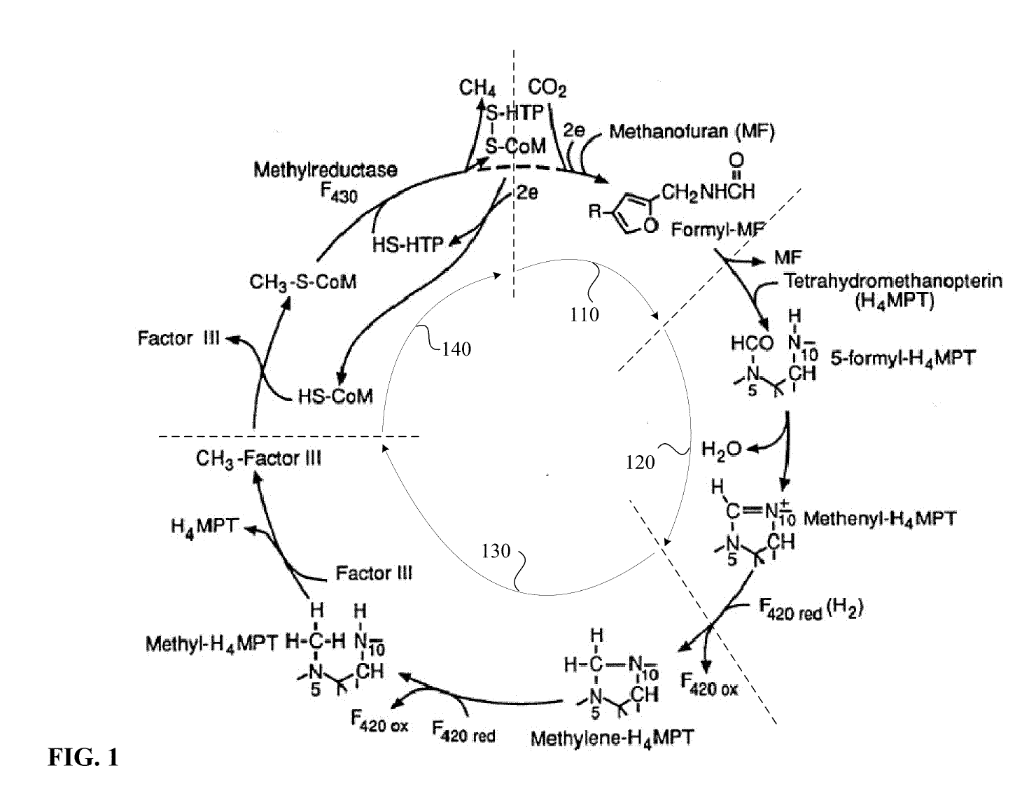

FIG. 1 illustrates a CO₂—CH₄ reduction pathway that occurs within methanogens 100. The reduction pathway 100 includes the following steps: carbon dioxide is reduced to the formyl level 110, the formyl group is reduced to the formaldehyde level 120, the methylene group is reduced to the methyl level 130, and the methyl group is converted to methane 140.

The reduction of CO₂ to the formyl level 110 is catalyzed by formyl-methanofuran dehydrogenase (FMF). FMF is the first stable intermediate in the pathway. Enzyme activity in the reverse direction is linked to the reduction of either methylviologen or coenzyme F₄₂₀ in all extracts of M. thermoautotrophicum strain.

Prior to the reduction of the formyl level to the formaldehyde level 120, the formyl group is transferred to 5,6,7,8-tetrahydromethanopterin (see reaction 2 below), and then converted to the methenyl derivative by the dehydrating cyclization (see reaction 3 below).

FMF+H₄MPT→5-Formyl-H₄MPT+2MF, with ΔG°′=−4.4 kJ/mol (2)

5-Formyl-H₄MPT+H⁺→5,10-methenyl-H₄MPT⁺+H₂O, with ΔG°′=−4.6 kJ/mol (3)

The 5,10-methenyl-H₄MPT⁺ is then reduced to the formaldehyde level with reduced coenzyme F₄₂₀ (see reaction 4 below).

5,10-methenyl-H₄MPT⁺+F₄₂₀H₂→5,10-methylene-H₄MPT+F₄₂₀+H⁺, with ΔG°=+6.5 kJ/mol (4)

Coenzyme F₄₂₀ is an obligate two-electron carrier as mentioned above (redox potential ˜−350 mV) that donates or accepts a hydride ion. The disappearance of the 5,10-methenylene-H₄MPT dehydrogenase activity results into increasing dependence on F₄₂₀ as an electron acceptor during the purification procedure or upon exposure to the air.

The reduction of the methylene group to the methyl level 130 includes the 5,10-methylene-H₄MPT reductase utilizing the reduced F₄₂₀ (F₄₂₀H₂) as the physiological electron donor (see reaction 5 below).

5,10-methylene-H₄MPT+F₄₂₀H₂→5-methyl-H₄MPT+F₄₂₀, with ΔG°′=−5.2 kJ/mol (5)

Reaction 5 may proceed in either direction. However, the physiologically relevant methylene reduction is thermodynamically favored. Since H₂ is the source of electrons (see reaction 6 below), the reduction is exergonic and therefore could be associated with the generation of a primary electrochemical potential.

5,10-methylene-H₄MPT+H₂→5-methyl-H₄MPT, with ΔG°′=−14 kJ/mol (6)

The conversion of the methyl group to methane 140 includes the transfer of the methyl group to Coenzyme M prior to the reduction (see reaction 7 below).

5-methyl-H₄MPT+HS-CoM→CH₃—S-CoM+H₄MPT, with ΔG°′=−29.7 kJ/mol (7)

The CH₃—S-CoM methylreductase catalyzes (see reaction 8 below) and in the final reductive step of the reductive pathway CoM-S—S-HTP is reduced to the respective sulhydryl cofactors (see reaction 9 below).

CH₃—S-CoM+HS-HTP→CH₄+CoM-S—S-HTP, with ΔG°′=−45 kJ/mol (8)

CoM-S—S-HTP+H₂→HS-CoM+HS-HTP, with ΔG°′=−40 kJ/mol (9)

The various enzyme and co-enzyme systems include: i) 4-(β-D-ribofuranosyl)aminobenzene-5″-phosphate (β-RFA-P) synthase, an early step in the biosynthesis of tetrahydromethanopterin (H₄MPT), which is a modified folate that is of central importance in growth and energy metabolism of methanogens; ii) Coenzyme F₄₂₀ (8-hydroxy-5-deazaflavin) NADP oxidoreductase enzyme which plays a vital role in the formation of methane; iii) Coenzyme M (CoM), 2-sulfanylethanesulfonate cofactor the substrate for the methylreductase which catalyzes the terminal step in all methanogenic pathways; iv) Coenzyme B, 2-[(7-mercapto-1-oxoheptyl)amino]-3-phosphonooxybutanoic acid, is the second substrate for methyl-coenzyme M reductase, and as a consequence of the reaction; and v) Coenzyme A 3-hydroxy-3-methylglutaryl coenzyme A (HMG-CoA) reductase, is an enzyme that is very critical in methane production in Methanobrevibactor strains, since Archaea are the only bacteria known to possess biosynthetic HMG-CoA reductase

The current invention utilizes essential oils and/or saponins to disrupt the enzyme and coenzyme systems that are integral parts of the methanogenesis process. This disruption limits the growth and reproduction of the methanogens and thus limits the amount of methane produced during in situ remediation processes. At a wide range of concentrations the essential oils/saponins are typically found to be harmless to most other bacteria that may be present in the environment (e.g., an aquifer system). Accordingly, the current invention positively affects the ability of slower-growing, halo-respiring bacteria to compete with methanogens for the hydrogen donors that are present in the environment (having reducing conditions).

Essential oils are mixtures of aromatic chemicals present in plant material such as leaves, buds, flowers, fruit, bark, root, or wood, and are comprised of various terpenes, acids, aldehydes, alcohols, esters, and ketones. Nearly all essential oils are obtained by physical means, with most essential oils obtained by the process of steam distillation of plant materials. There are a few essential oils obtained using chemical solvent extractions. These products are termed “concretes” and “absolutes”. They are used in perfumes, cosmetics, soaps and other products, for flavoring food and drink, and for adding scents to incense and household cleaning products.

Saponins are glucosides with foaming characteristics. They consist of a polycyclic aglycones attached to one or more sugar side chains. The aglycone part, which is also called sapogenin, is either steroid (C27) or a triterpene (C30). The foaming ability of saponins is caused by the combination of a hydrophobic (fat-soluble) sapogenin and a hydrophilic (water-soluble) sugar part. Saponins have a bitter taste. Some saponins are toxic and are known as sapotoxin.

The essential oils/saponins utilized to disrupt the enzyme and coenzyme systems in order to limit the methanogenesis process may include, but are not limited to, garlic oil (Allium sativum), lemongrass oil (Cymbopogon citratus), clove oil (Syzgium aromaticum) and/or cinnamon bark oil (Cinnamomum zeylanicum).

Laboratory studies (bench-scale tests) were performed to demonstrate the ability of various essential oils to control methanogenesis. Manure and groundwater samples were collected from a site in Monticello, Wis. at 1:1 ratio. The collected samples were added to 125 mL amber glass bottles equipped with PTFE-lined open septum caps (VOA vials). The testing program included 40 vials each filled with 20 g manure slurry and 20 g groundwater. All samples were sacrificial and disposed after completion of the analyses.

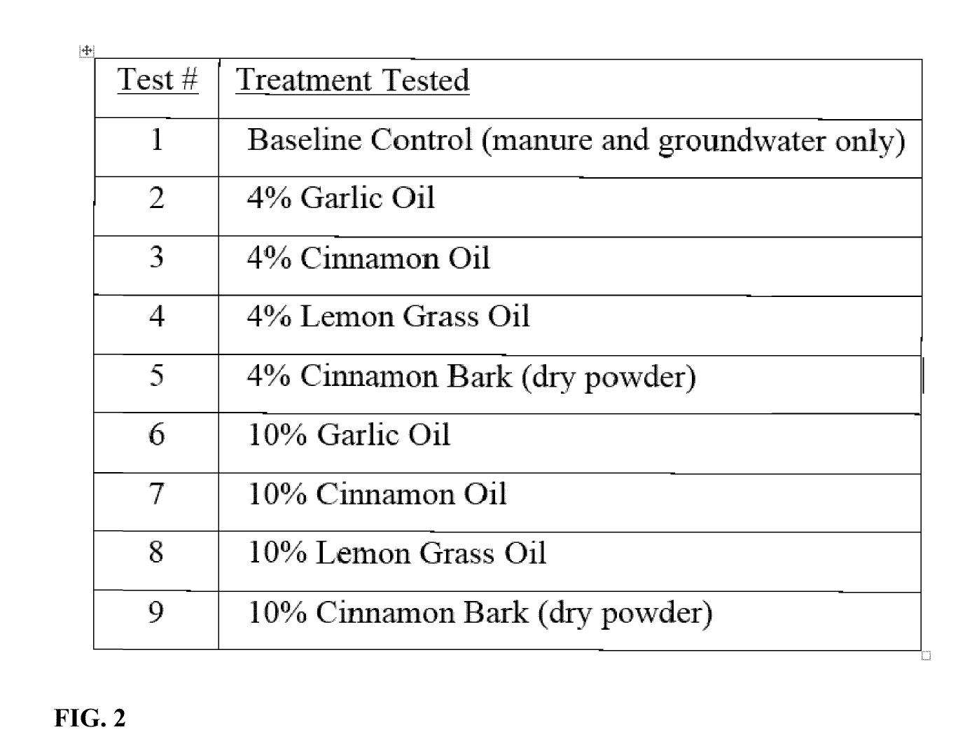

FIG. 2 is a table of the various different essential oils that were tested to determine their effect on methane production (compared to a baseline control). It was determined that methanogen production began 4 days after the vials were prepared with the manure slurry and groundwater. After four days (on the fifth day), the vials were dosed with different essential oils. The essential oils utilized included garlic oil (GO), cinnamon bark oil (CO), cinnamon bark powder (CB) and lemongrass oil (LO). Each of these essential oils were utilized at a 4% and a 10% dosage level. A total of 27 vials were prepared to compare the 8 different essential oil mixes to a control sample for 3 different time intervals. The time intervals were 3 days after dosing (7 days after set up), 7 days after dosing (11 days after set up), and 12 days after dosing (16 days after set up).

Five (5) vials were used to indicate the onset of anaerobic conditions by measuring pH, ORP and methane over a 2-week period. Eight (8) vials were setup as replicate samples. Gas samples from the sample container headspace were analyzed for methane in the gas phase using a gas chromatograph (GC) with a flame ionization detector (FID). After these analyses were completed, pH and ORP were also measured.

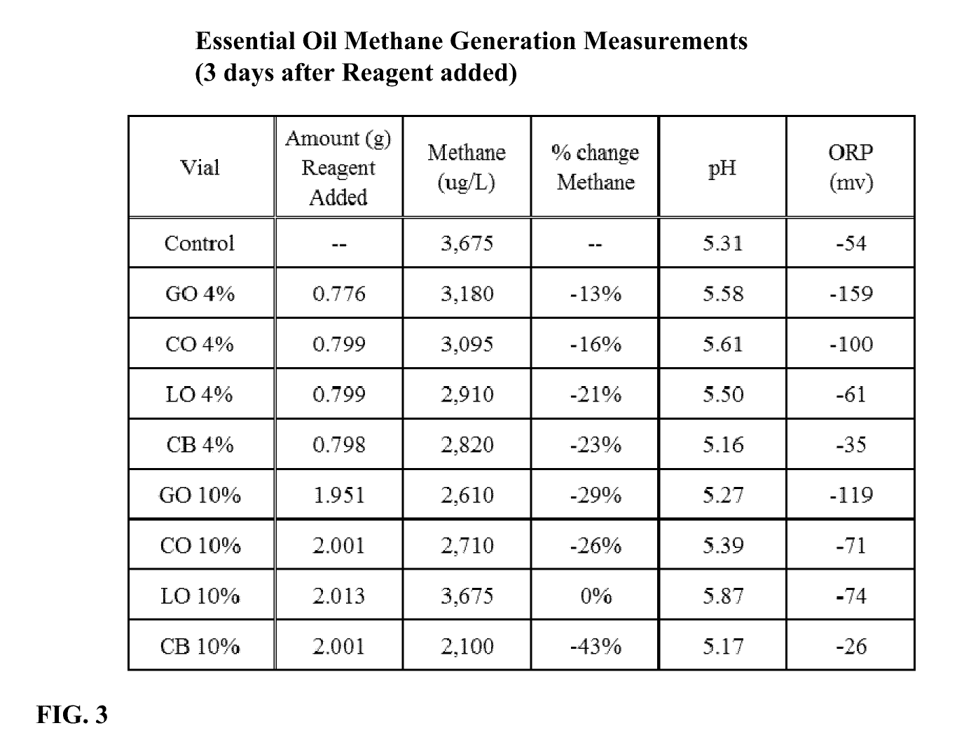

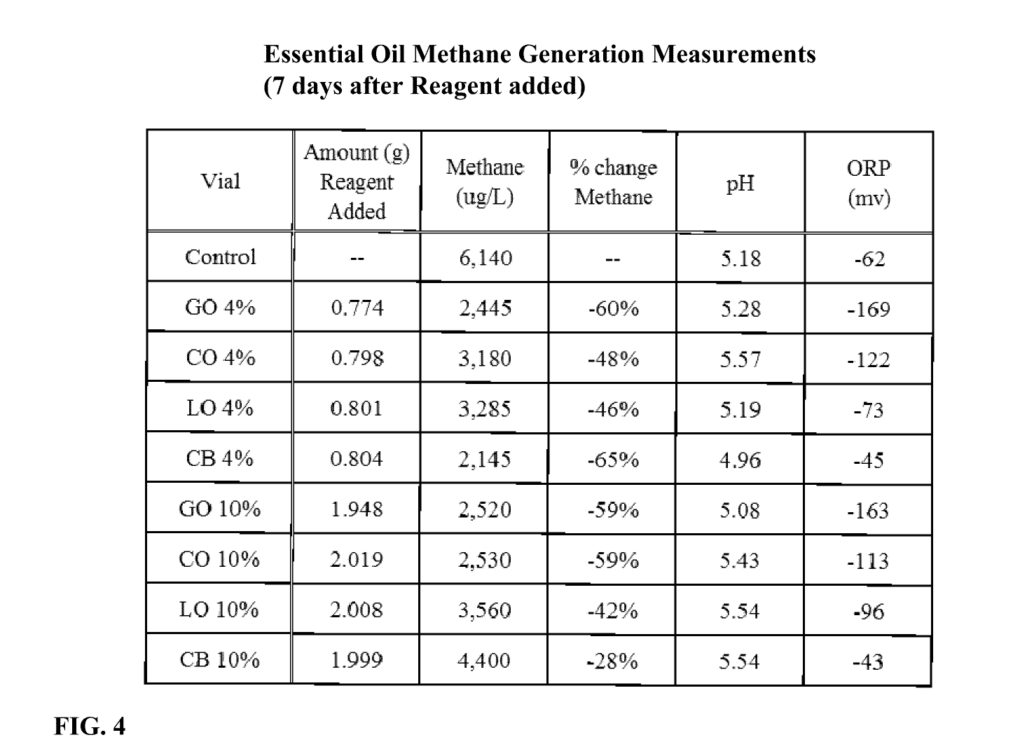

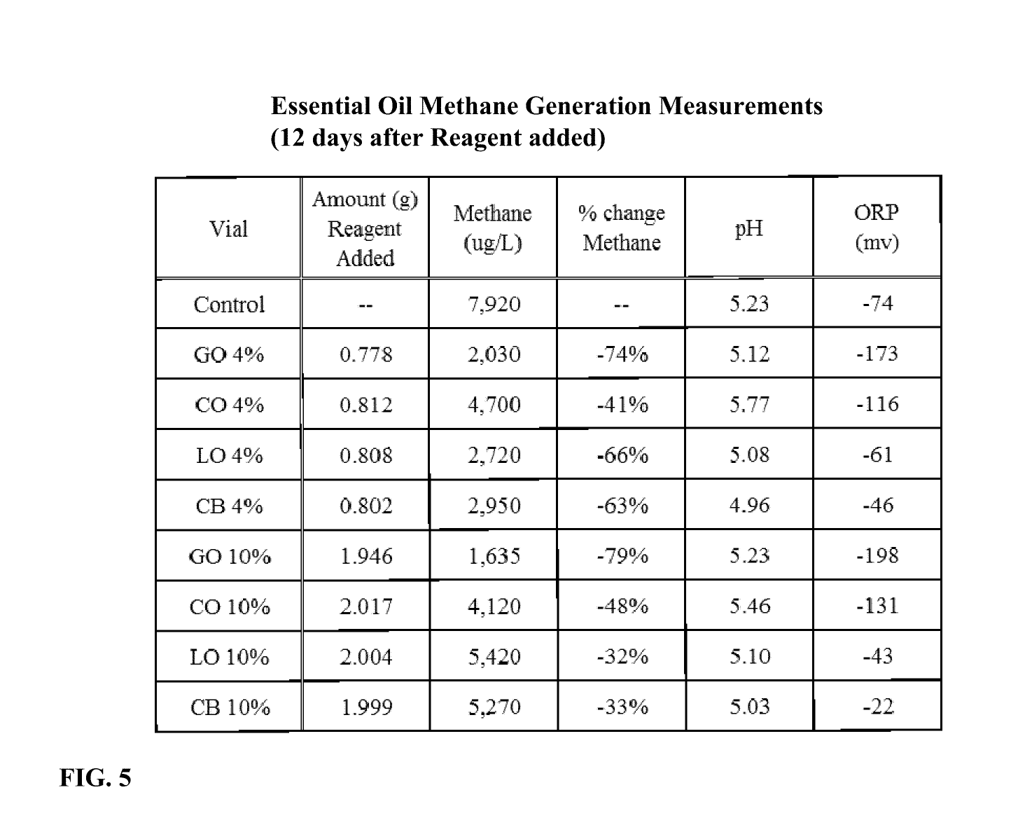

FIGS. 3-5 are the measurements recorded for the control sample and each of the essential oil mixtures noted in FIG. 2 for the 3 time intervals (3, 7 and 12 days after the essential oils were added). As is readily apparent from the percentage change in methane column, there was a substantial drop in the methane measured for the essential oil mixtures compared to the baseline. The various essential oils were shown to effectively control methanogenesis.

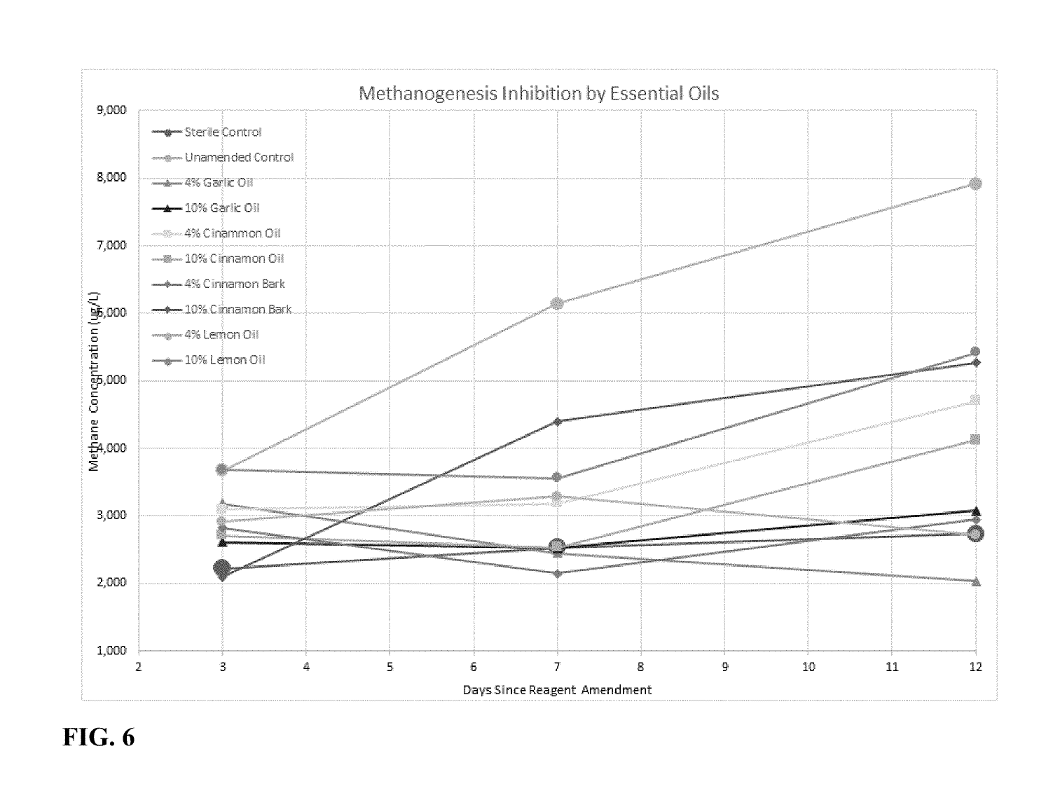

FIG. 6 is a graph showing the methane measured for each of the essential oil mixtures at the 3 time intervals. The graph shows how the amount of methane produced utilizing the different mixtures is reduced as compared to the baseline for the different time intervals.

The introduction of the essential oils/saponins in the subsurface can be achieved through various applications. These applications can be utilized in order to inject the essential oils/saponins either via pumping processes as a liquid or through an induced gas stream. The main applications used to provide remedial material (such as the essential oils/saponins) into an environment medium include direct-push injection (DPI) methods, injection well (IW) methods, hydraulic and pneumatic fracturing injection methods.

DPI methods rely on the hydraulic downward advancement of hollow steel rods into the target zone and the displacement of soil and groundwater around the diameter of rod tip. Soil displacement via the DPI rods creates localized areas of compaction immediately around the injection rods. Once the DPI point is installed pressure is applied to inject a slurry of remedial material in the subsurface.

Injection wells are typically used in order to gravity feed the remedial material in an aquifer. Most Injection wells are commonly constructed of polyvinylchloride (PVC) or stainless steel pipe and are usually made with the intention of being temporary or semi-permanent. More permanent type wells such as monitoring wells or pumping wells can also be used for injection purposes.

Pneumatic fracturing uses a gas to fracture the media and inject the remedial material, with or without the use of packers to isolate the injection depth. The pneumatic fracturing is used to create or enhance subsurface fractures with controlled bursts of high-pressure gas at pressures exceeding the natural in situ geostatic pressures and at flow volumes exceeding the natural permeability of the subsurface.

The essential oils/saponins can be provided in various combinations, strategies, preparations and formulations. The essential oils/saponins can be injected alone or along with various organic hydrogen donors, zero-valent iron (ZVI) or other surfactants in order to enhance the biodegradation of the targeted contaminants (support desired biological reductive dechlorination reactions while controlling the production of methane during remedial actions, and in other environmental applications). The essential oils/saponins (hydrophobic oils) are very amenable to co-application with other hydrophobic organic hydrogen donors, and they can be applied in conjunction with a myriad of other fermentable carbon sources.

If the essential oils/saponins are provided along with other materials (e.g., organic hydrogen donors, ZVI), the essential oils/saponins may be provided concurrently or sequentially (before or after) to the other materials.

The amount of essential oils/saponins required to control methanogenesis in an environmental medium may depend on various parameters including the type of environmental medium, the amount of methane being produced, whether contaminants are present in the environmental medium and if so what the containments are and at what levels, if any other materials (e.g., organic hydrogen donors, ZVI) are being provided to the environmental medium to reduce the contaminants, and what the time frame is for biological remediation of the contaminants. According to one embodiment, the essential oils/saponins may be provided at dosages of between approximately 4% and 10% of the ground water concentration of the environmental medium.

Various fermentable substrates (e.g., liquid, solid, fibrous, emulsified) may be provided to the environmental medium to act as an organic hydrogen donor in order to provide additional H₂ to be utilized by the dehalogenating bacteria during reductive dechlorination of CAHs during in situ remediation processes. By way of example, some useful fermentable substrates include, but are not limited to carbohydrates including glucose and glucose-producing compounds; acetate; propionate; butyrate; benzoate; lactate; formate; methanol; toluene; molasses; cheese whey; corn steep liquor; oils including corn oil, peanut oil, coconut oil, vegetable oil, fish oil, soybean oil, hydrogenated cottonseed oil beads; solid food shortening, beef tallow; melted corn oil margarine; filamentous plant material; chitin and hydrogenated soybean. Inorganic hydrogen sources can drive the desired biological reactions and are also included herein.

The amount and type of organic hydrogen donor utilized to support biological remediation in an environmental medium may depend on various parameters including the type of environmental medium, what the containments are present therein and at what levels, and how long the desired reduction period is. For example, applications where remediation is required over a longer period of time may utilize organic hydrogen donors that ferment over longer periods of time so that H₂ is available to be utilized by the dehalogenating bacteria over a longer period of time. The activity of methanogens within the reducing environment that compete for the available H₂ is also a consideration in the amount and type of organic hydrogen donor utilized. In summary, the amount and type of organic hydrogen donor utilized is specific to each remediation project.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

What is claimed is:

1. A method for inhibiting methane production by a methanogen within an environmental medium, the method comprising:
providing an essential oil and/or saponin to the environmental medium, wherein the essential oil/saponin contacts methanogens that are indigenous to the environmental medium and inhibit methane production of the methanogens.

2. The method of claim 1, wherein the essential oil/saponin includes garlic oil, lemongrass oil, cinnamon bark oil, cinnamon bark powder or some combination thereof.

3. The method of claim 1, the essential oil/saponin includes dry powders, lyophilized products, oils, distilled residual, pressed oils, or some combination thereof.

4. The method of claim 1, wherein the essential oil/saponin disrupt enzyme and coenzyme systems that are integral parts of a methanogenesis process of the methanogens.

5. The method of claim 4, wherein the essential oil/saponin blocks 4-(β-D-ribofuranosyl)aminobenzene-5′-phosphate (β-RFA-P) synthase in a methane production pathway of the methanogen.

6. The method of claim 4, wherein the essential oil/saponin blocks 3-hydroxy-3-ethylglutaryl coenzyme A (HMG-CoA) reductase in a methane production pathway of the methanogen.

7. The method of claim 4, wherein the essential oil/saponin blocks 8-hydroxy-5-deazaflavin (coenzyme F₄₂₀) in a methane production pathway of the methanogen.

8. The method of claim 1, further comprising providing a fermentable substrate the environmental medium to provide an organic hydrogen donor.

9. The method of claim 8, wherein the providing essential oil/saponin and the providing the fermentable substrate are provided to the environmental medium concurrently as a combination.

10. The method of claim 8, wherein the providing essential oil/saponin and the providing the fermentable substrate are provided to the environmental medium sequentially.

11. A method for increasing reductive dechlorination of an environmental medium and inhibiting methane production by methanogens within the environmental medium, the method comprising:
injecting essential oil and/or saponin into the environmental medium so as to contact the methanogens within the environmental medium, wherein the essential oil/saponin inhibit methane production of the methanogens and thus limits growth and reproduction of the methanogens; and
injecting a fermentable substrate into the environmental medium to provide an organic hydrogen donor to be utilized by dehalogenating bacteria.

12. The method of claim 11, wherein the essential oil/saponin includes garlic oil, lemongrass oil, cinnamon bark oil, cinnamon bark powder or some combination thereof.

13. The method of claim 11, wherein the essential oil/saponin includes dry powders, lyophilized products, oils, distilled residual, pressed oils, or some combination thereof.

14. The method of claim 11, wherein the essential oil/saponin disrupt enzyme and coenzyme systems that are integral parts of a methanogenesis process of the methanogens.

15. The method of claim 11, wherein the fermentable substrate includes at least some combination of acetate, propionate, butyrate, benzoate, lactate, formate, methanol, toluene, molasses, cheese whey, corn steep liquor, corn oil, peanut oil, coconut oil, vegetable oil, fish oil, soybean oil, hydrogenated cottonseed oil beads, solid food shortening, beef tallow, melted corn oil margarine, filamentous plant material, chitin and hydrogenated soybean.

16. The method of claim 11, wherein the fermentable substrate is a carbohydrate including a glucose, a glucose-producing compound or a combination thereof.

17. The method of claim 11, wherein the essential oil/saponin and the fermentable substrate are injected into the environmental medium concurrently.

18. The method of claim 11, wherein the essential oil/saponin and the fermentable substrate are injected into the environmental medium sequentially.

19. The method of claim 11, wherein the injecting the essential oil/saponin and the injecting the fermentable substrate utilize at least some subset of direct-push injection (DPI) methods, injection well (IW) methods, hydraulic fracturing injection methods and pneumatic fracturing injection methods.

20. The method of claim 11, further comprising injecting zero valent iron into the environmental medium.
